(19) United States
(12) Patent Application Publication
(10) Pub. No.: US 2023/0256965 A1
(43) Pub. Date: Aug. 17, 2023

(54) CONTROL SYSTEM OF UNMANNED VEHICLE, UNMANNED VEHICLE, AND METHOD OF CONTROLLING UNMANNED VEHICLE

(71) Applicant: Komatsu Ltd., Tokyo (JP)

(72) Inventor: Shun Sasaki, Tokyo (JP)

(73) Assignee: Komatsu Ltd., Tokyo (JP)

(21) Appl. No.: 18/011,989

(22) PCT Filed: May 24, 2021
(86) PCT No.: PCT/JP2021/019616

§ 371 Date: Dec. 21, 2022

(30) Foreign Application Priority Data
Jul. 29, 2020 (JP) 2020-128167

(51) Int. Cl. B60W 30/14; B60W 60/00

(52) U.S. Cl. CPC B60W 30/143; B60W 60/001; B60W 2300/125; B60W 2510/205; B60W 2540/18

(57) ABSTRACT

A control system of an unmanned vehicle includes: a requested steering speed calculation unit that calculates a requested steering speed of the unmanned vehicle such that the unmanned vehicle travels along a traveling course; an actual steering speed acquisition unit that acquires an actual steering speed of the unmanned vehicle detected by a steering sensor; and a traveling control unit that adjusts a traveling speed of the unmanned vehicle based on a result of comparison between the requested steering speed and the actual steering speed.

### FIELD

The present disclosure relates to a control system of an unmanned vehicle, the unmanned vehicle, and a method of controlling the unmanned vehicle.

### BACKGROUND

As disclosed in Patent Literature 1, an unmanned vehicle operates in a wide work site such as a mine.

### CITATION LIST

### Patent Literature

Patent Literature 1: JP 2020-021280 A

### SUMMARY

### Technical Problem

An unmanned vehicle travels in a work site along a traveling course. When the unmanned vehicle travels at a high speed, the unmanned vehicle may deviate from the traveling course. If the unmanned vehicle deviates from the traveling course, the operation of the unmanned vehicle is stopped, and productivity at the work site may be decreased.

An object of the present disclosure is to inhibit a decrease in productivity at a work site where an unmanned vehicle operates.

### Solution to Problem

According to an aspect of the present invention, a control system of an unmanned vehicle comprises: a requested steering speed calculation unit that calculates a requested steering speed of the unmanned vehicle such that the unmanned vehicle travels along a traveling course; an actual steering speed acquisition unit that acquires an actual steering speed of the unmanned vehicle detected by a steering sensor; and a traveling control unit that adjusts a traveling speed of the unmanned vehicle based on a result of comparison between the requested steering speed and the actual steering speed.

### Advantageous Effects of Invention

According to the present disclosure, a decrease in productivity at a work site where an unmanned vehicle operates is inhibited.

### BRIEF DESCRIPTION OF DRAWINGS

FIG. 1 is a schematic diagram illustrating a management system of an unmanned vehicle according to an embodiment.

FIG. 2 is a schematic diagram illustrating the unmanned vehicle according to the embodiment.

FIG. 3 is a schematic diagram illustrating a work site according to the embodiment.

FIG. 4 is a schematic diagram for illustrating course data according to the embodiment.

FIG. 5 is a functional block diagram illustrating a control system of the unmanned vehicle according to the embodiment.

FIG. 6 is a schematic diagram for illustrating a traveling condition of the unmanned vehicle according to the embodiment.

FIG. 7 is a flowchart illustrating a method of controlling the unmanned vehicle according to the embodiment.

FIG. 8 is a schematic diagram for illustrating operation of the unmanned vehicle according to the embodiment.

### DESCRIPTION OF EMBODIMENTS

An embodiment of the present disclosure will be described below with reference to the drawings, but the present disclosure is not limited to the embodiment. Components in the embodiment described below can be appropriately combined. Furthermore, some components are not used in some cases.

[Management System]

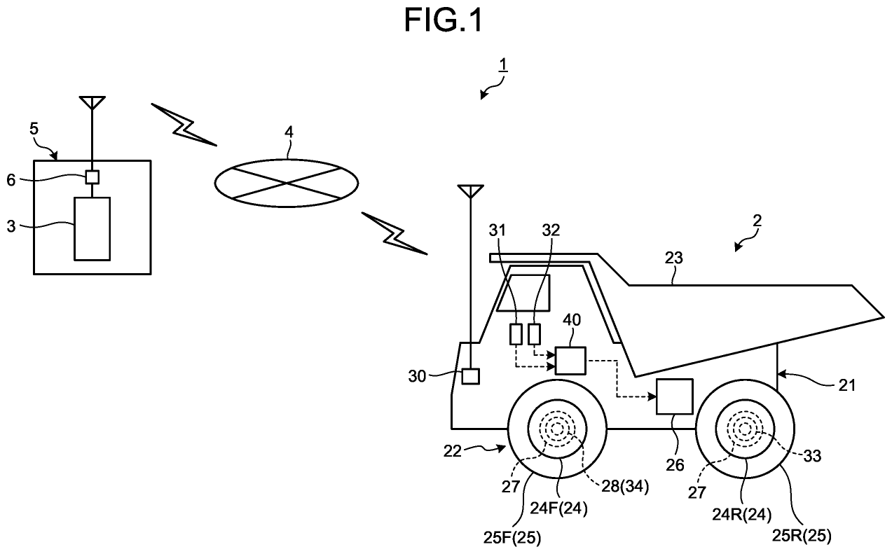

FIG. 1 is a schematic diagram illustrating a management system 1 of an unmanned vehicle 2 according to the embodiment. The unmanned vehicle 2 refers to a work vehicle that operates in an unmanned manner without depending on a driving operation of a driver. The unmanned vehicle 2 operates at a work site. Examples of the work site include a mine or a quarry. The unmanned vehicle 2 is an unmanned dump truck that travels in an unmanned manner at a work site and transports a cargo. The mine refers to a place or business facilities for mining minerals. The quarry refers to a place or business facilities for mining stones. Examples of a cargo transported by the unmanned vehicle 2 include ore and sediment excavated in the mine or the quarry.

The management system 1 includes a management device 3 and a communication system 4. The management device 3 includes a computer system. The management device 3 is installed in a control facility 5 of the work site. An administrator is in the control facility 5. The management device 3 and the unmanned vehicle 2 wirelessly communicate with each other via the communication system 4. A wireless communication device 6 is connected to the management device 3. The communication system 4 includes the wireless communication device 6. The management device 3 generates course data indicating a traveling condition of the unmanned vehicle 2. The unmanned vehicle 2 operates at the work site based on the course data transmitted from the management device 3.

[Unmanned Vehicle]

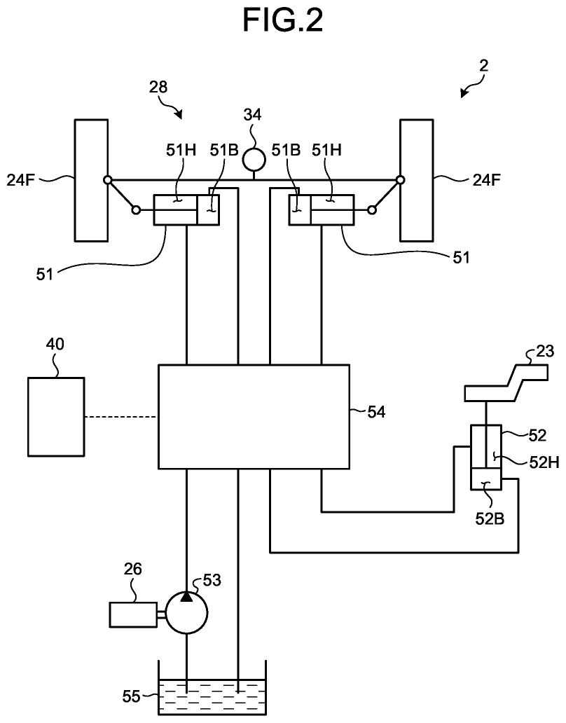

FIG. 2 is a schematic diagram illustrating the unmanned vehicle 2 according to the embodiment. As illustrated in FIGS. 1 and 2, the unmanned vehicle 2 includes a vehicle body 21, a traveling device 22, a dump body 23, a wireless communication device 30, a position sensor 31, an orientation sensor 32, a speed sensor 33, a steering sensor 34, and a control device 40.

The vehicle body 21 includes a vehicle body frame. The vehicle body 21 is supported by the traveling device 22. The vehicle body 21 supports the dump body 23.

The traveling device 22 causes the unmanned vehicle 2 to travel. The traveling device 22 causes the unmanned vehicle 2 to move forward or rearward. At least a part of the traveling device 22 is disposed below the vehicle body 21. The traveling device 22 includes wheels 24, tires 25, a drive device 26, a brake device 27, and a steering device 28.

The tires 25 are mounted on the wheels 24. The wheels 24 include front wheels 24F and rear wheels 24R. The tires 25 include front tires 25F and rear tires 25R. The front tires 25F are mounted on the front wheels 24F. The rear tires 25R are mounted on the rear wheels 24R.

The drive device 26 generates driving force for starting or accelerating the unmanned vehicle 2. Examples of the drive device 26 include an internal combustion engine and an electric motor. Examples of the internal combustion engine include a diesel engine. Driving force generated by the drive device 26 is transmitted to the rear wheels 24R, which rotates the rear wheels 24R. Rotation of the rear wheels 24R causes the unmanned vehicle 2 to be self-propelled.

The brake device 27 generates braking force for stopping or decelerating the unmanned vehicle 2. Examples of the brake device 27 include a disc brake and a drum brake.

The steering device 28 generates steering force for adjusting a traveling direction of the unmanned vehicle 2. The traveling direction of the unmanned vehicle 2 moving forward refers to an orientation of a front portion of the vehicle body 21. The traveling direction of the unmanned vehicle 2 moving rearward refers to an orientation of a rear portion of the vehicle body 21. As illustrated in FIG. 2, the steering device 28 includes a steering cylinder 51. The steering cylinder 51 is a hydraulic cylinder. The front wheels 24F are steered by steering force generated by the steering cylinder 51. The traveling direction of the unmanned vehicle 2 is adjusted by the front wheels 24F being steered.

The dump body 23 is a member on which a cargo is loaded. At least a part of the dump body 23 is disposed above the vehicle body 21. As illustrated in FIG. 2, the dump body 23 moves up and down by operations of a hoist cylinder 52. The hoist cylinder 52 is a hydraulic cylinder. The dump body 23 is adjusted to have a loading posture or a dump posture by force of moving up and down generated by the hoist cylinder 52. The loading posture refers to a posture in which the dump body 23 is lowered. The dump posture refers to a posture in which the dump body 23 is raised.

As illustrated in FIG. 2, the unmanned vehicle 2 includes a hydraulic pump 53, a valve device 54, and a hydraulic oil tank 55.

The hydraulic pump 53 is operated by driving force generated by the drive device 26. The hydraulic pump 53 discharges hydraulic oil for driving each of the steering cylinder 51 and the hoist cylinder 52. The hydraulic pump 53 sucks and discharges hydraulic oil stored in the hydraulic oil tank 55.

The valve device 54 adjusts a flow state of the hydraulic oil supplied to each of the steering cylinder 51 and the hoist cylinder 52. The valve device 54 operates based on a control command from the control device 40. The valve device 54 includes a first flow rate adjusting valve and a second flow rate adjusting valve. The first flow rate adjusting valve can adjust the flow rate and direction of hydraulic oil supplied to the steering cylinder 51. The second flow rate adjusting valve can adjust the flow rate and direction of hydraulic oil supplied to the hoist cylinder 52.

The steering cylinder 51 includes a bottom chamber 51B and a head chamber 51H. When hydraulic oil discharged from the hydraulic pump 53 is supplied to the bottom chamber 51B via the valve device 54, the steering cylinder 51 extends. When the hydraulic oil discharged from the hydraulic pump 53 is supplied to the head chamber 51H via the valve device 54, the steering cylinder 51 contracts. The hydraulic oil discharged from the steering cylinder 51 is returned to the hydraulic oil tank 55 via the valve device 54. The front wheels 24F are coupled to the steering cylinder 51 via a link mechanism. The front wheels 24F are steered by the extension and contraction of the steering cylinder 51.

The hoist cylinder 52 includes a bottom chamber 52B and a head chamber 52H. When the hydraulic oil discharged from the hydraulic pump 53 is supplied to the bottom chamber 52B via the valve device 54, the hoist cylinder 52 extends. When the hydraulic oil discharged from the hydraulic pump 53 is supplied to the head chamber 52H via the valve device 54, the hoist cylinder 52 contracts. The hydraulic oil discharged from the hoist cylinder 52 is returned to the hydraulic oil tank 55 via the valve device 54. The dump body 23 is coupled to the hoist cylinder 52. The dump body 23 is moved up and down by the extension and contraction of the hoist cylinder 52.

The wireless communication device 30 wirelessly communicates with the wireless communication device 6. The communication system 4 includes the wireless communication device 30.

The position sensor 31 detects a position of the unmanned vehicle 2. The position of the unmanned vehicle 2 is detected by using a global navigation satellite system (GNSS). The global navigation satellite system includes a global positioning system (GPS). The global navigation satellite system detects the position in a global coordinate system specified by coordinate data of latitude, longitude, and altitude. The global coordinate system refers to a coordinate system fixed to the earth. The position sensor 31 includes a GNSS receiver, and detects the position of the unmanned vehicle 2 in the global coordinate system.

The orientation sensor 32 detects an orientation of the unmanned vehicle 2. The orientation of the unmanned vehicle 2 includes a traveling direction of the unmanned vehicle 2. Examples of the orientation sensor 32 include a gyro sensor.

The speed sensor 33 detects a traveling speed of the unmanned vehicle 2.

The steering sensor 34 detects a steering angle of the steering device 28. Examples of the steering sensor 34 include a potentiometer.

The control device 40 includes a computer system. The control device 40 is disposed in the vehicle body 21. The control device 40 can communicate with the management device 3. The control device 40 outputs a control command for controlling the traveling device 22. The control command output from the control device 40 includes a driving command for operating the drive device 26, a braking command for operating the brake device 27, and a steering command for operating the steering device 28. The drive device 26 generates driving force for starting or accelerating the unmanned vehicle 2 based on the driving command output from the control device 40. The brake device 27 generates braking force for stopping or decelerating the unmanned vehicle 2 based on the braking command output from the control device 40. The steering device 28 generates steering force for causing the unmanned vehicle 2 to move straight or turn based on the steering command output from the control device 40.

[Work Site]

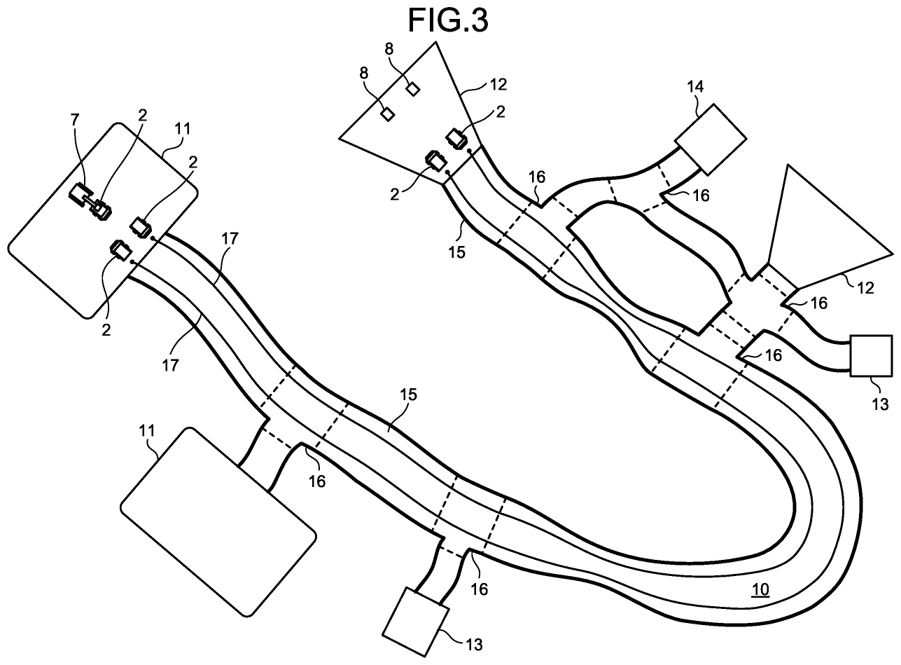

FIG. 3 is a schematic diagram illustrating the work site according to the embodiment. In the embodiment, the work site is a mine. Examples of the mine include a metal mine for mining metal, a non-metal mine for mining limestone, and a coal mine for mining coal. Examples of a cargo transported by the unmanned vehicle 2 include mined objects excavated in the mine.

A traveling area 10 is set in the work site. In the traveling area 10, the unmanned vehicle 2 is permitted to travel. The unmanned vehicle 2 can travel in the traveling area 10. The traveling area 10 includes a loading place 11, a soil discharging place 12, a parking place 13, an oil filling place 14, a traveling path 15, and an intersection 16.

The loading place 11 refers to an area for performing loading operation of loading a cargo on the unmanned vehicle 2. When the loading operation is performed, the dump body 23 is adjusted to have a loading posture. In the loading place 11, a loader 7 operates. Examples of the loader 7 include a hydraulic shovel. A driver boards the loader 7. The loader 7 is a manned vehicle that operates based on a driving operation of the driver.

The soil discharging place 12 refers to an area for performing discharging operation of discharging a cargo from the unmanned vehicle 2. When the discharging operation is performed, the dump body 23 is adjusted to have a dump posture. A crusher 8 is provided in the soil discharging place 12.

The parking place 13 is an area for parking the unmanned vehicle 2.

The oil filling place 14 is an area for filling the unmanned vehicle 2 with oil.

The traveling path 15 refers to an area where the unmanned vehicle 2 travels toward at least one of the loading place 11, the soil discharging place 12, the parking place 13, and the oil filling place 14. The traveling path 15 is provided so as to connect at least the loading place 11 and the soil discharging place 12. In the embodiment, the traveling path 15 is connected to each of the loading place 11, the soil discharging place 12, the parking place 13, and the oil filling place 14.

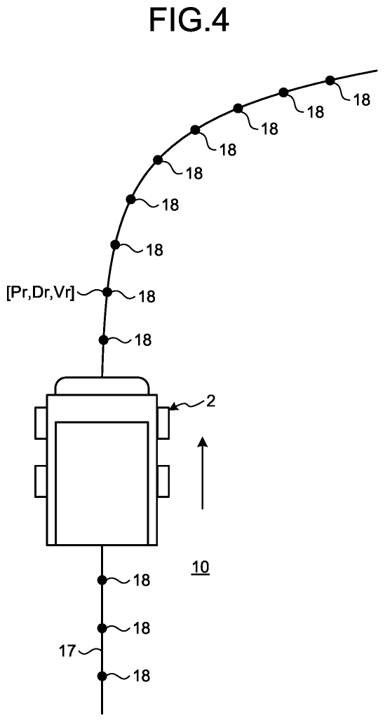

The intersection 16 refers to an area where a plurality of traveling paths 15 intersects or an area where one traveling path 15 branches into a plurality of traveling paths 15.

[Course Data] FIG. 4 is a schematic diagram for illustrating course data according to the embodiment. The management device 3 generates the course data. The course data indicates a traveling condition of the unmanned vehicle 2. The course data is set in the traveling area 10. The unmanned vehicle 2 travels in the traveling area 10 based on the course data transmitted from the management device 3. The course data includes course points 18, a traveling course 17 of the unmanned vehicle 2, target positions Pr of the unmanned vehicle 2, target orientations Dr of the unmanned vehicle 2, and target traveling speeds Vr of the unmanned vehicle 2.

As illustrated in FIG. 4, a plurality of course points 18 is set in the traveling area 10. The course points 18 specify the target positions Pr of the unmanned vehicle 2. The target orientations Dr of the unmanned vehicle 2 and the target traveling speeds Vr of the unmanned vehicle 2 are set at the plurality of course points 18. The plurality of course points 18 is set at intervals. The interval between the course points 18 is set to, for example, 1 [m] or more and 5 [m] or less. The intervals between the course points 18 may be uniform or non-uniform.

The traveling course 17 refers to a virtual line indicating a target traveling route of the unmanned vehicle 2. The traveling course 17 is specified by a track passing through the plurality of course points 18. The control device 40 controls the traveling device 22 so that the unmanned vehicle 2 travels along the traveling course 17. In the embodiment, the control device 40 controls the traveling device 22 so that the unmanned vehicle 2 travels with the center of the unmanned vehicle 2 in a vehicle width direction coinciding with the traveling course 17.

The target positions Pr of the unmanned vehicle 2 refer to target positions of the unmanned vehicle 2 at the time when the unmanned vehicle 2 passes through the course points 18. The control device 40 controls the traveling device 22 so that actual positions Ps of the unmanned vehicle 2 at the time when the unmanned vehicle 2 passes through the course points 18 correspond to the target positions Pr based on detection data of the position sensor 31. The control device 40 controls the traveling device 22 so that the unmanned vehicle 2 travels along the traveling course 17 based on the detection data of the position sensor 31. The target positions Pr of the unmanned vehicle 2 may be specified in a local coordinate system of the unmanned vehicle 2 or a global coordinate system.

The target orientations Dr of the unmanned vehicle 2 refer to target orientations of the unmanned vehicle 2 at the time when the unmanned vehicle 2 passes through the course points 18. The target orientations Dr include orientation angles of the unmanned vehicle 2 with respect to a reference orientation (e.g., north). In the embodiment, the target orientations Dr are target orientations of the front portion of the vehicle body 21, and indicate a target traveling direction of the unmanned vehicle 2. The control device 40 controls the traveling device 22 so that actual orientations Ds of the unmanned vehicle 2 at the time when the unmanned vehicle 2 passes through the course points 18 correspond to the target orientations Dr based on detection data of the orientation sensor 32. For example, when a target orientation Dr at a first course point 18 is set to a first target orientation Dr1, the control device 40 controls the steering device 28 so that an actual orientation Ds of the unmanned vehicle 2 at the time when the unmanned vehicle 2 passes through the first course point 18 corresponds to a first target orientation Dr1. When a target orientation Dr at a second course point 18 is set to a second target orientation Dr2, the control device 40 controls the steering device 28 so that an actual orientation Ds of the unmanned vehicle 2 at the time when the unmanned vehicle 2 passes through the second course point 18 corresponds to a second target orientation Dr2.

The target traveling speeds Vr of the unmanned vehicle 2 refer to target traveling speeds of the unmanned vehicle 2 at the time when the unmanned vehicle 2 passes through the course points 18. The control device 40 controls the traveling device 22 so that actual traveling speeds Vs of the unmanned vehicle 2 at the time when the unmanned vehicle 2 passes through the course points 18 correspond to the target traveling speeds Vr based on detection data of the speed sensor 33. For example, when a target traveling speed Vr at the first course point 18 is set to a first target traveling speed Vr1, the control device 40 controls the drive device 26 or the brake device 27 so that an actual traveling speed Vs of the unmanned vehicle 2 at the time when the unmanned vehicle 2 passes through the first course point 18 corresponds to the first target traveling speed Vr1. When a target traveling speed Vr at the second course point 18 is set to a second target traveling speed Vr2, the control device 40 controls the drive device 26 or the brake device 27 so that an actual traveling speed Vs of the unmanned vehicle 2 at the time when the unmanned vehicle 2 passes through the second course point 18 corresponds to the second target traveling speed Vr2.

[Control System]

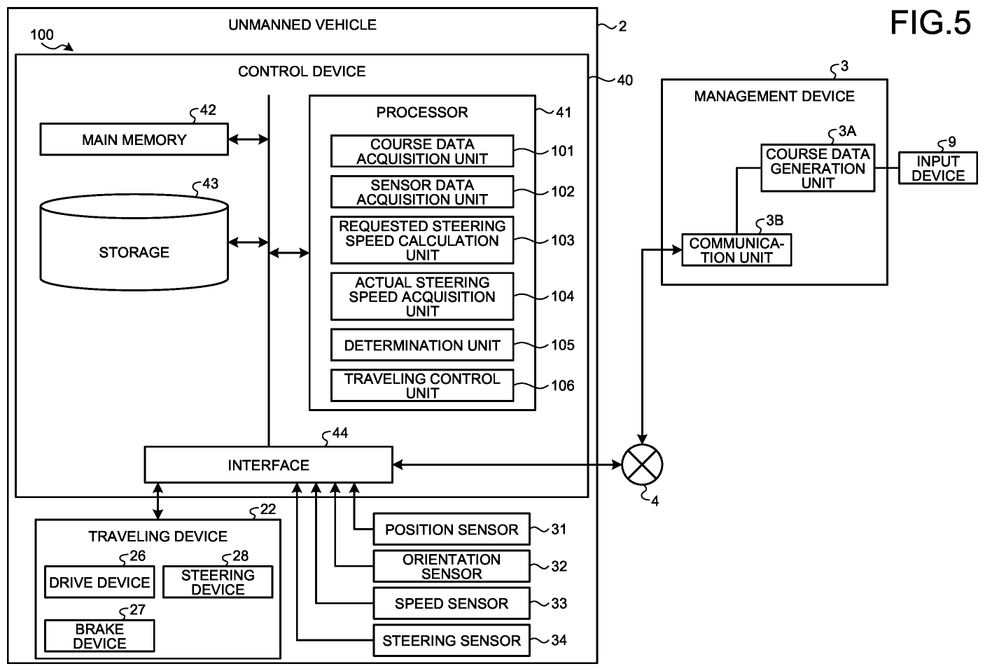

FIG. 5 is a functional block diagram illustrating a control system 100 of the unmanned vehicle 2 according to the embodiment. The control system 100 includes the control device 40 and the traveling device 22. The management device 3 and the control device 40 of the unmanned vehicle 2 wirelessly communicate with each other via the communication system 4.

The control device 40 includes a processor 41, a main memory 42, a storage 43, and an interface 44. Examples of the processor 41 include a central processing unit (CPU) and a micro processing unit (MPU). Examples of the main memory 42 include a nonvolatile memory and a volatile memory. Examples of the nonvolatile memory include a read only memory (ROM). Examples of the volatile memory include a random access memory (RAM). Examples of the storage 43 include a hard disk drive (HDD) and a solid state drive (SSD). Examples of the interface 44 include an input/output circuit and a communication circuit.

The interface 44 is connected to each of the traveling device 22, the position sensor 31, the orientation sensor 32, the speed sensor 33, and the steering sensor 34. The interface 44 communicates with each of the traveling device 22, the position sensor 31, the orientation sensor 32, the speed sensor 33, and the steering sensor 34.

The control device 40 includes a course data acquisition unit 101, a sensor data acquisition unit 102, a requested steering speed calculation unit 103, an actual steering speed acquisition unit 104, a determination unit 105, and a traveling control unit 106. The processor 41 functions as the course data acquisition unit 101, the sensor data acquisition unit 102, the requested steering speed calculation unit 103, the actual steering speed acquisition unit 104, the determination unit 105, and the traveling control unit 106.

The course data acquisition unit 101 acquires course data transmitted from the management device 3 via the interface 44.

The sensor data acquisition unit 102 acquires sensor data via the interface 44. The sensor data includes at least one of detection data of the position sensor 31, detection data of the orientation sensor 32, detection data of the speed sensor 33, and detection data of the steering sensor 34.

The requested steering speed calculation unit 103 calculates a requested steering speed v_{req} of the steering device 28 of the unmanned vehicle 2 so that the unmanned vehicle 2 travels along the traveling course 17.

The requested steering speed calculation unit 103 calculates the requested steering speed v_{req} based on the course data acquired by the course data acquisition unit 101 and the sensor data acquired by the sensor data acquisition unit 102. In the embodiment, the requested steering speed calculation unit 103 calculates the requested steering speed v_{req} based on a target steering angle δ_{com} and an actual steering angle δᵣₑₐₗ detected by the steering sensor 34.

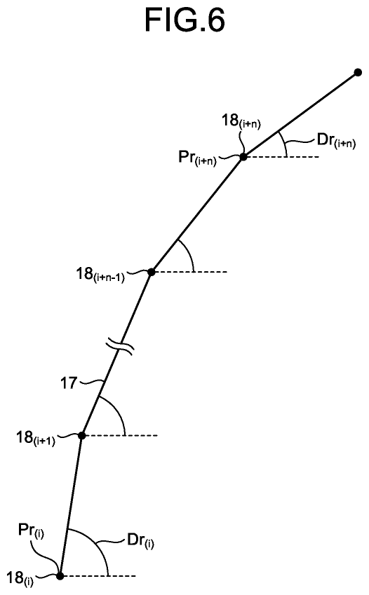

FIG. 6 is a schematic diagram for illustrating a traveling condition of the unmanned vehicle 2 according to the embodiment. FIG. 6 illustrates an example in which the traveling course 17 is set so that the unmanned vehicle 2 turns. In the example in FIG. 6, course points 18₍ᵢ₎ to 18₍ᵢ₊ₙ₎ are set as the course points 18. The unmanned vehicle 2 travels in the traveling area 10 so as to pass through the course point 18₍ᵢ₎ and then the course point 18₍ᵢ₊ₙ₎. The target positions Pr, the target orientations Dr, and the target traveling speeds Vr are set at the plurality of course points 18.

In a traveling direction of the unmanned vehicle 2, the course point 18₍ᵢ₊ₙ₎ is in front of the course point 18₍ᵢ₎. The requested steering speed calculation unit 103 calculates a difference ΔPr₍ᵢ₎ between a target position Pr₍ᵢ₎ of the course point 18₍ᵢ₎ and sensor data (detection data of position sensor 31) acquired by the sensor data acquisition unit 102. Furthermore, the requested steering speed calculation unit 103 calculates a difference ΔDr₍ᵢ₎ between a target orientation Dr₍ᵢ₎ of the course point 18₍ᵢ₎ and sensor data (detection data of orientation sensor 32) acquired by the sensor data acquisition unit 102.

The requested steering speed calculation unit 103 calculates a target steering angle δ_{com(i)} of the unmanned vehicle 2 that travels from the course point 18₍ᵢ₎ to the course point 18₍ᵢ₊ₙ₎ based on the difference ΔPr₍ᵢ₎, the difference ΔDr₍ᵢ₎, the target position Pr₍ᵢ₊ₙ₎ at the course point 18₍ᵢ₊ₙ₎, the target orientation Dr₍ᵢ₊ₙ₎ at the course point 18₍ᵢ₊ₙ₎, and the like.

The actual steering angle δᵣₑₐₗ is detection data of the steering sensor 34. The requested steering speed calculation unit 103 acquires the actual steering angle δᵣₑₐₗ, which is the detection data of the steering sensor 34 from the sensor data acquisition unit 102.

The requested steering speed calculation unit 103 can acquire the actual steering angle δᵣₑₐₗ₍ᵢ₎ detected by the steering sensor 34 of the unmanned vehicle 2 at the course point 18₍ᵢ₎.

The requested steering speed calculation unit 103 calculates the requested steering speed v_{req} for the unmanned vehicle 2 to travel along the traveling course 17 based on the target steering angle δ_{com} and the actual steering angle δᵣₑₐₗ The requested steering speed v_{req} is calculated based on Expression (1) below.

v_{req}=(α/T)×(S_{com}−δᵣₑₐₗ) (1)

In Expression (1), a time T is a time expected to be taken for the unmanned vehicle 2 to arrive at a target arrival point. The time T is calculated based on the distance from the current point of the unmanned vehicle 2 to the target arrival time point and a traveling speed Vs of the unmanned vehicle 2. For example, when the unmanned vehicle 2 at the course point 18₍ᵢ₎ travels toward the course point 180₍ᵢ₊ₙ₎, which is the target arrival point, the time T is a time required for the unmanned vehicle 2 to move from the course point 18₍ᵢ₎ to the course point 18₍ᵢ₊ₙ₎. The time T is calculated based on the distance from the course point 18₍ᵢ₎ to the course point 18₍ᵢ₊ₙ₎ and the traveling speed Vs of the unmanned vehicle 2 at the time when the unmanned vehicle 2 passes through the course point 18₍ᵢ₎. The distance from the course point 18₍ᵢ₎ to the course point 18₍ᵢ₊ₙ₎ is specified by the course data. The speed sensor 33 detects the traveling speed Vs of the unmanned vehicle 2 at the time when the unmanned vehicle 2 passes through the course point 18₍ᵢ₎. Here, α is a constant. The constant α is, for example, three.

The requested steering speed calculation unit 103 calculates a requested steering speed v_{req(i)} so that the unmanned vehicle 2 at the course point 18₍ᵢ₎ does not deviate from the traveling course 17 at the course point 18₍ᵢ₊ₙ₎. That is, the requested steering speed calculation unit 103 calculates the requested steering speed v_{req(i)} based on Expression (1) so that the unmanned vehicle 2 that travels from the course point 18₍ᵢ₎ to the course point 18₍ᵢ₊ₙ₎ does not deviate from the traveling course 17.

The actual steering speed acquisition unit 104 acquires an actual steering speed vᵣₑₐₗ of the steering device 28 of the unmanned vehicle 2 detected by the steering sensor 34. The actual steering speed vᵣₑₐₗ is detection data of the steering sensor 34. The actual steering speed acquisition unit 104 acquires the actual steering speed vᵣₑₐₗ from the steering sensor 34. Note that, when the steering sensor 34 detects a steering angle, the actual steering speed acquisition unit 104 may acquire the actual steering speed vᵣₑₐₗ by differentiating the steering angle detected by the steering sensor 34.

The actual steering speed acquisition unit 104 can acquire an actual steering speed vᵣₑₐₗ₍ᵢ₎ detected by the steering sensor 34 of the unmanned vehicle 2 at the course point 18₍ᵢ₎.

The determination unit 105 determines whether or not the unmanned vehicle 2 can travel along the traveling course 17 based on a result of comparison between the requested steering speed v_{req} and the actual steering speed vᵣₑₐₗ That is, the determination unit 105 determines whether or not the unmanned vehicle 2 can travel without deviating from the traveling course 17 based on the result of comparison between the requested steering speed v_{req} and the actual steering speed vᵣₑₐₗ.

For example, the determination unit 105 determines whether or not the unmanned vehicle 2 that travels from the course point 18₍ᵢ₎ to the course point 18₍ᵢ₊ₙ₎ can travel without deviating from the traveling course 17 based on the result of comparison between the requested steering speed v_{req(i)} and the actual steering speed vᵣₑₐₗ₍ᵢ₎.

When the requested steering speed v_{req} is higher than the actual steering speed vᵣₑₐₗ and the difference between the requested steering speed v_{req} and the actual steering speed vᵣₑₐₗ exceeds a predetermined threshold β, the determination unit 105 determines that the unmanned vehicle 2 cannot travel along the traveling course 17. That is, when a condition of Expression (2) below is satisfied, the determination unit 105 determines that the unmanned vehicle 2 cannot travel along the traveling course 17.

v_{req}−vᵣₑₐₗ>β (2)

The threshold β is zero. Note that the threshold β may be a positive number.

In Expression (2), the actual steering speed vᵣₑₐₗ is detection data of the steering sensor 34 at the time when the control device 40 drives the steering device 28 of the unmanned vehicle 2 at the maximum output. In the embodiment, the actual steering speed vᵣₑₐₗ at the time when the control device 40 drives the steering device 28 at the maximum output is appropriately referred to as a maximum steering speed.

That is, when determining that the actual steering speed vᵣₑₐₗ cannot reach the requested steering speed v_{req} even if the steering device 28 of the unmanned vehicle 2 at the first course point 18₍ᵢ₎ is driven at the maximum steering speed, the determination unit 105 determines that the unmanned vehicle 2 deviates from the traveling course 17 at the second course point 18₍ᵢ₊ₙ₎ in front of the unmanned vehicle 2, and determines that the unmanned vehicle 2 cannot travel along the traveling course 17.

In contrast, when the difference between the requested steering speed v_{req} and the actual steering speed vᵣₑₐₗ is equal to or less than the threshold β, the determination unit 105 determines that the unmanned vehicle 2 can travel along the traveling course 17. In the embodiment, when the requested steering speed v_{req} is equal to or less than the actual steering speed vᵣₑₐₗ, the determination unit 105 determines that the unmanned vehicle 2 can travel along the traveling course 17.

The traveling control unit 106 controls the traveling device 22 based on the course data acquired by the course data acquisition unit 101. Furthermore, the traveling control unit 106 adjusts the traveling speed Vs of the unmanned vehicle 2 based on the result of comparison between the requested steering speed v_{req} and the actual steering speed vᵣₑₐₗ.

When the determination unit 105 determines that the unmanned vehicle 2 cannot travel along the traveling course 17 based on the result of comparison between the requested steering speed v_{req} and the actual steering speed vᵣₑₐₗ, the traveling control unit 106 reduces the traveling speed Vs of the unmanned vehicle 2.

When an actual traveling speed at the time when the unmanned vehicle 2 passes through the first course point 18 is Vs, the traveling control unit 106 reduces the traveling speed Vs so that the traveling speed Vs becomes equal to or less than a traveling speed Vt indicated by Expression (3).

Vt≤(vᵣₑₐₗ/v_{req})×Vs (3)

When the determination unit 105 determines that the unmanned vehicle 2 can travel along the traveling course 17 based on the result of comparison between the requested steering speed v_{req} and the actual steering speed vᵣₑₐₗ, the traveling control unit 106 causes the unmanned vehicle 2 to travel based on the target traveling speed Vr specified by the course data.

The management device 3 includes a course data generation unit 3A and a communication unit 3B.

The course data generation unit 3A generates course data indicating a traveling condition of the unmanned vehicle 2. An administrator of the control facility 5 operates an input device 9 connected to the management device 3 to input the traveling condition of the unmanned vehicle 2 to the management device 3. Examples of the input device 9 include a touch panel, a computer keyboard, a mouse, and an operation button. The input device 9 is operated by the administrator to generate input data. The course data generation unit 3A generates course data based on the input data generated by the input device 9. The course data generation unit 3A transmits the course data to the unmanned vehicle 2 via the communication unit 3B and the communication system 4.

[Control Method]

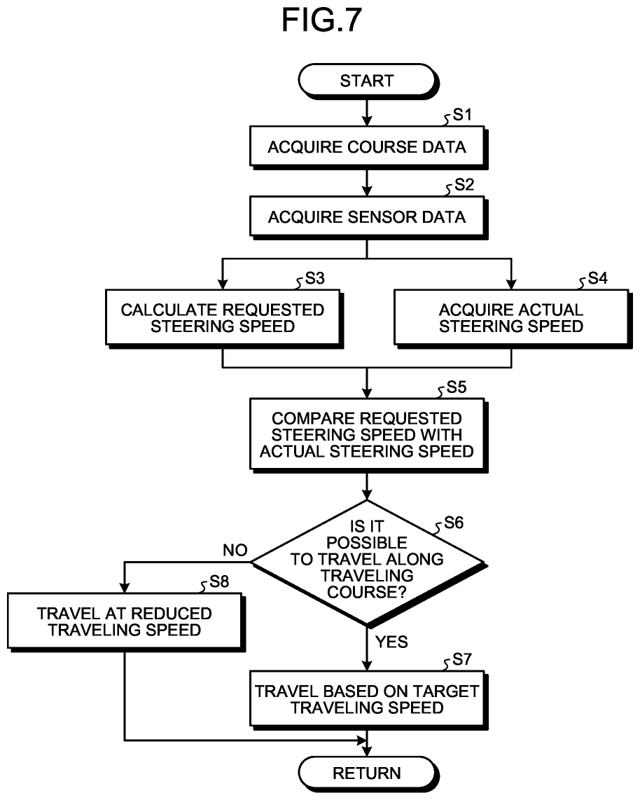

FIG. 7 is a flowchart illustrating a method of controlling the unmanned vehicle 2 according to the embodiment. Course data is transmitted from the management device 3 to the control device 40. The course data acquisition unit 101 acquires the course data transmitted from the management device 3 (Step S1).

The traveling control unit 106 outputs a control command for controlling the traveling device 22 so that the unmanned vehicle 2 travels based on the course data. The unmanned vehicle 2 travels in the traveling area 10 based on the course data.

The sensor data acquisition unit 102 acquires sensor data (Step S2).

The sensor data acquired in Step S2 includes detection data of the position sensor 31, detection data of the orientation sensor 32, detection data of the speed sensor 33, and detection data of the steering sensor 34. Detection data of the steering sensor 34 is the actual steering angle δᵣₑₐₗ.

The requested steering speed calculation unit 103 calculates the requested steering speed v_{req} based on the target steering angle δ_{com} and the actual steering angle δᵣₑₐₗ (Step S3).

The requested steering speed calculation unit 103 calculates the target steering angle δ_{com} based on the course data acquired in Step S1 and the sensor data acquired in Step S2. The requested steering speed calculation unit 103 calculates the target steering angle δ_{com} based on the target positions Pr and the target orientations Dr at the course points 18 and the sensor data. Furthermore, the requested steering speed calculation unit 103 acquires the actual steering angle δᵣₑₐₗ acquired in Step S2. The requested steering speed calculation unit 103 calculates the requested steering speed v_{req} for the unmanned vehicle 2 to travel along the traveling course 17 based on Expression (1).

The actual steering speed acquisition unit 104 acquires the actual steering speed vᵣₑₐₗ based on the actual steering angle δᵣₑₐₗ acquired in Step S2 (Step S4).

The determination unit 105 compares the requested steering speed v_{req} calculated in Step S3 with the actual steering speed vᵣₑₐₗ acquired in Step S4 (Step S5).

The determination unit 105 determines whether or not the unmanned vehicle 2 can travel along the traveling course 17 based on the comparison result in Step S5 (Step S6).

The determination unit 105 determines whether or not the unmanned vehicle 2 can travel along the traveling course 17 based on Expression (2). In the embodiment, when the requested steering speed v_{req} is equal to or less than the actual steering speed vᵣₑₐₗ, the determination unit 105 determines that the unmanned vehicle 2 can travel along the traveling course 17. When the requested steering speed v_{req} exceeds the actual steering speed vᵣₑₐₗ, the determination unit 105 determines that the unmanned vehicle 2 cannot travel along the traveling course 17.

When it is determined in Step S6 that the unmanned vehicle 2 can travel along the traveling course 17 (Step S6: Yes), the traveling control unit 106 causes the unmanned vehicle 2 to travel based on the target traveling speed Vr specified by the course data (Step S7).

When it is determined in Step S6 that the unmanned vehicle 2 cannot travel along the traveling course 17 (Step S6: No), the traveling control unit 106 operates the brake device 27 to reduce the traveling speed Vs, and causes the unmanned vehicle 2 to travel (Step S8).

[Effects]

As described above, according to the embodiment, the requested steering speed v_{req} for causing the unmanned vehicle 2 to travel along the traveling course 17 is calculated. The requested steering speed v_{req} is calculated based on the difference ΔPr, the difference ΔDr, the target steering angle δ_{com}, the actual steering angle δᵣₑₐₗ, and the time T. The difference ΔPr is a difference between the target position Pr of the first course point 18 and the sensor data (detection data of position sensor 31). The difference ΔDr is a difference between the target orientation Dr of the first course point 18 and the sensor data (detection data of orientation sensor 32). The target steering angle δ_{com} is derived from the target position Pr and the target orientation Dr of the second course point 18 in front of the first course point 18. The actual steering angle δᵣₑₐₗ is detected by the steering sensor 34 when the unmanned vehicle 2 passes through the first course point 18. The time T is required for the unmanned vehicle 2 to move from the first course point 18 to the second course point 18. The time T is calculated based on the distance from the first course point 18 to the second course point 18 and the traveling speed Vs of the unmanned vehicle 2 at the time when the unmanned vehicle 2 passes through the first course point 18. The distance from the first course point 18 to the second course point 18 is specified by the course data. The speed sensor 33 detects the traveling speed Vs of the unmanned vehicle 2 at the time when the unmanned vehicle 2 passes through the first course point 18. Furthermore, the steering sensor 34 detects the actual steering speed vᵣₑₐₗ at the time when the unmanned vehicle 2 passes through the first course point 18. The traveling speed Vs of the unmanned vehicle 2 is adjusted based on the result of comparison between the requested steering speed v_{req} and the actual steering speed vᵣₑₐₗ This inhibits a decrease in productivity at the work site.

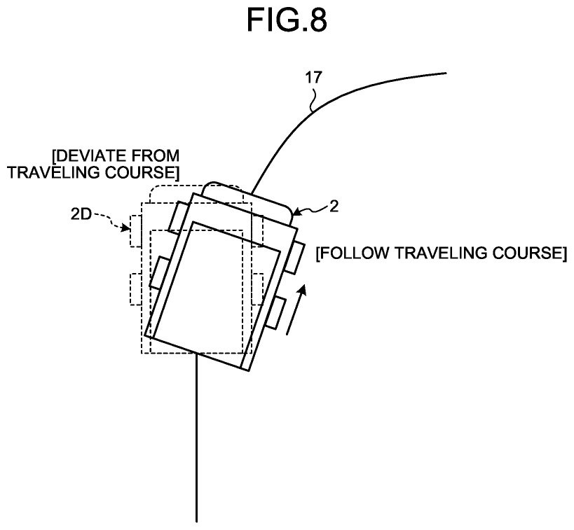

FIG. 8 is a schematic diagram for illustrating operation of the unmanned vehicle 2 according to the embodiment. As illustrated in FIG. 8, when the unmanned vehicle 2 travels on a curve specified by the traveling course 17, the actual traveling speed Vs may be higher than the target traveling speed Vr specified by the course data. For example, when the traveling area 10 where the unmanned vehicle 2 travels is a downhill road or cargos are loaded in the dump body 23, the actual traveling speed Vs may be higher than the target traveling speed Vr. Furthermore, the actual traveling speed Vs may be higher than the target traveling speed Vr also immediately after the stopped unmanned vehicle 2 starts. When the unmanned vehicle 2 enters the curve at the high traveling speed Vs, the unmanned vehicle 2 may fail to go around the curve to deviate from the traveling course 17 as illustrated by an unmanned vehicle 2D in FIG. 8.

In the embodiment, when it is determined that the unmanned vehicle 2 cannot travel along the traveling course 17 based on the result of comparison between the requested steering speed v_{req} and the actual steering speed vᵣₑₐₗ, that is, when it is determined that the unmanned vehicle 2 cannot go around the curve even if the steering device 28 of the unmanned vehicle 2 entering the curve at the traveling speed Vs is operated at the maximum steering speed, the brake device 27 is operated to reduce the traveling speed Vs of the unmanned vehicle 2. Reduction of the traveling speed Vs of the unmanned vehicle 2 allows the unmanned vehicle 2 to travel so as to follow the traveling course 17. Since deviation of the unmanned vehicle 2 from the traveling course 17 is inhibited, a decrease in productivity at the work site is inhibited.

In contrast, when it is determined that the unmanned vehicle 2 can travel along the traveling course 17 based on the result of comparison between the requested steering speed v_{req} and the actual steering speed vᵣₑₐₗ, the traveling speed Vs of the unmanned vehicle 2 is not reduced. Since the traveling speed Vs of the unmanned vehicle 2 is not reduced, the unmanned vehicle 2 can arrive at a destination place in a short time. For example, the traveling speed Vs of the unmanned vehicle 2 is not reduced when the unmanned vehicle 2 travels toward the soil discharging place 12, so that the unmanned vehicle 2 can arrive at the soil discharging place 12 in a short time. Therefore, a decrease in productivity at the work site is inhibited.

### OTHER EMBODIMENTS

Note that, in the above-described embodiment, at least a part of the functions of the control device 40 may be provided in the management device 3, or at least a part of the functions of the management device 3 may be provided in the control device 40. For example, in the above-described embodiment, the management device 3 may have the function of the requested steering speed calculation unit 103, and the requested steering speed v_{req} calculated based on a change command in the management device 3 may be transmitted to the control device 40 of the unmanned vehicle 2 via the communication system 4. Furthermore, the management device 3 may have the function of the determination unit 105, and a determination result of the determination unit 105 may be transmitted to the control device 40 of the unmanned vehicle 2 via the communication system 4. When the determination unit 105 of the management device 3 determines that the unmanned vehicle 2 cannot travel along the traveling course 17, the traveling control unit 106 of the control device 40 reduces the traveling speed Vs of the unmanned vehicle 2.

### REFERENCE SIGNS LIST

1 MANAGEMENT SYSTEM
2 UNMANNED VEHICLE
3 MANAGEMENT DEVICE
3A COURSE DATA GENERATION UNIT
3B COMMUNICATION UNIT
4 COMMUNICATION SYSTEM
5 CONTROL FACILITY
6 WIRELESS COMMUNICATION DEVICE
7 LOADER
8 CRUSHER
9 INPUT DEVICE
10 TRAVELING AREA
11 LOADING PLACE
12 SOIL DISCHARGING PLACE
13 PARKING PLACE
14 OIL FILLING PLACE
15 TRAVELING PATH
16 INTERSECTION
17 TRAVELING COURSE
18 COURSE POINT
21 VEHICLE BODY
22 TRAVELING DEVICE
23 DUMP BODY
24 WHEEL
24F FRONT WHEEL
24R REAR WHEEL
25 TIRE
25F FRONT TIRE
25R REAR TIRE
26 DRIVE DEVICE
27 BRAKE DEVICE
28 STEERING DEVICE
30 WIRELESS COMMUNICATION DEVICE
31 POSITION SENSOR
32 ORIENTATION SENSOR
33 SPEED SENSOR
34 STEERING SENSOR
40 CONTROL DEVICE
41 PROCESSOR
42 MAIN MEMORY
43 STORAGE
44 INTERFACE
51 STEERING CYLINDER
51B BOTTOM CHAMBER
51H HEAD CHAMBER
52 HOIST CYLINDER
52B BOTTOM CHAMBER
52H HEAD CHAMBER
53 HYDRAULIC PUMP
54 VALVE DEVICE
55 HYDRAULIC OIL TANK
100 CONTROL SYSTEM
101 COURSE DATA ACQUISITION UNIT
102 SENSOR DATA ACQUISITION UNIT
103 REQUESTED STEERING SPEED CALCULATION UNIT
104 ACTUAL STEERING SPEED ACQUISITION UNIT
105 DETERMINATION UNIT
106 TRAVELING CONTROL UNIT
Pr TARGET POSITION
Ps POSITION
Vr TARGET TRAVELING SPEED
Vs TRAVELING SPEED
Vt TRAVELING SPEED
Dr TARGET ORIENTATION
Ds ORIENTATION
ΔDr DIFFERENCE
α CONSTANT
β THRESHOLD
v_{req} REQUESTED STEERING SPEED
vᵣₑₐₗ ACTUAL STEERING SPEED
δ_{com} TARGET STEERING ANGLE
δᵣₑₐₗ ACTUAL STEERING ANGLE

1. A control system of an unmanned vehicle, comprising:
a requested steering speed calculation unit that calculates a requested steering speed of the unmanned vehicle such that the unmanned vehicle travels along a traveling course;
an actual steering speed acquisition unit that acquires an actual steering speed of the unmanned vehicle detected by a steering sensor; and
a traveling control unit that adjusts a traveling speed of the unmanned vehicle based on a result of comparison between the requested steering speed and the actual steering speed.

2. The control system of an unmanned vehicle according to claim 1, further comprising
a determination unit that determines whether or not the unmanned vehicle is allowed to travel along the traveling course based on the result of comparison,
wherein when it is determined that the unmanned vehicle is not allowed to travel along the traveling course, the traveling control unit reduces a traveling speed of the unmanned vehicle.

3. The control system of an unmanned vehicle according to claim 2,
wherein when the requested steering speed is higher than the actual steering speed and a difference between the requested steering speed and the actual steering speed exceeds a threshold, the determination unit determines that the unmanned vehicle is not allowed to travel along the traveling course.

4. The control system of an unmanned vehicle according to claim 2,
wherein the traveling course is specified by a track passing through a plurality of course points,
a target orientation and a target traveling speed of the unmanned vehicle are set for each of the plurality of course points, and
the requested steering speed calculation unit calculates the requested steering speed such that the unmanned vehicle at a first course point does not deviate from the traveling course at a second course point in front of the unmanned vehicle.

5. The control system of an unmanned vehicle according to claim 4,
wherein when it is determined that the unmanned vehicle deviates from the traveling course at the second course point even if a steering device of the unmanned vehicle is driven at a maximum steering speed, the determination unit determines that the unmanned vehicle is not allowed to travel along the traveling course.

6. The control system of an unmanned vehicle according to claim 2,
wherein when the requested steering speed is equal to or less than the actual steering speed, the determination unit determines that the unmanned vehicle is allowed to travel along the traveling course.

7. An unmanned vehicle comprising
the control system of an unmanned vehicle according to claim 1.

8. A method of controlling an unmanned vehicle, comprising:
calculating a requested steering speed of the unmanned vehicle such that the unmanned vehicle travels along a traveling course;
acquiring an actual steering speed of the unmanned vehicle detected by a steering sensor; and
adjusting a traveling speed of the unmanned vehicle based on a result of comparison between the requested steering speed and the actual steering speed.
